(19) United States
(12) Patent Application Publication
(10) Pub. No.: US 2007/0145838 A1
(43) Pub. Date: Jun. 28, 2007

(54) Motor and Method of Manufacturing Housing

(75) Inventors: Yoshihiro Uchitani, Kyoto (JP); Koji Isogai, Kyoto (JP); Hidehiro Haga, Kyoto (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: NIDEC CORPORATION, Kyoto (JP)

(21) Appl. No.: 11/567,748

(22) Filed: Dec. 7, 2006

(30) Foreign Application Priority Data
Dec. 7, 2005 (JP) 2005-353924
Dec. 28, 2005 (JP) 2005-377060

(51) Int. Cl. H02K 11/00; H02K 5/16; H02K 21/12

(52) U.S. Cl. 310/68 B; 310/156.05; 310/90; 310/156.22; 310/71

(57) ABSTRACT

A housing (11) including a bearing retainer is formed as one member. One pair of bearings is arranged in the bearing retainer and the shaft is rotatably supported by the pair of bearings. The region for retaining the bearing is reduced in the axis direction and thus the motor is miniaturized by supporting the rotor including the shaft by a so-called cantilever structure.

### BACKGROUND OF THE INVENTION

1. Technical Field

The present invention relates to an electrically operated motor and a method of manufacturing the same.

2. Description of the Related Art

The electrically operated motor is recently being used in various mechanisms of an automobile such as power source etc. of power steering and fuel supply pump. For example, an electrically operated power steering motor is disclosed in which a frame having a bottomed cylindrical shape for accommodating a cylindrical stator is fixed to a housing, and a shaft of a rotor is held by a front bearing attached to the center of the housing and a rear bearing attached to the center of the bottom part of the frame.

The electrically operated power steering (hereinafter referred to as “EPS” (electric power steering)) using the motor is given attention as an efficient system in which the power loss of the engine is small compared to a hydraulic power steering in which the engine output is directly transmitted to oil. In the motor used for such EPS, miniaturization and higher reliability of the motor are desired in view of fuel consumption, kinematic performance etc. of the vehicle.

Since a pair of bearings is held by individual bearing holders from both end sides of the shaft in the above described motor, the region occupied by the bearing holder increases in the axis direction, and thus the motor enlarges in the axis direction. Furthermore, the degree of coaxiality between the bearings also lowers. Moreover, since a resolver including a rotor and a stator is used as a sensor for detecting the rotating position, the sensor itself also enlarges.

A brushless motor in which the position of the magnetic pole of the rotor magnet is indirectly detected by detecting the change in magnetic field generated by a sensor magnet arranged separate from the rotor magnet by means of a sensor such as Hall element is conventionally known.

When the rotor magnet and the sensor magnet are respectively attached to different members of the rotor as in the brushless motor, a troublesome task of aligning the positions in the peripheral direction of the rotor magnet and the sensor magnet is necessary. Furthermore, the number of components configuring the rotor increases. The manufacturing cost and the number of man hour for the motor thus increase.

The shape of the rotor core becomes complex if the sensor magnet is arranged in the rotor core.

### BRIEF SUMMARY OF THE INVENTION

The electrically operated motor of one example of the present invention includes a stationary section including a stator; a rotor including a rotor magnet facing the stator, a bearing for rotatably supporting the rotor with the central axis as the center, and a housing having a substantially bottomed cylindrical shape formed as one member for accommodating the stationary section and the rotor.

The housing includes a tubular part, a bottom part, and a bearing retainer of a substantially cylindrical shape. A stator is arranged on the inner side of the tubular part, and the bottom part covers the lower end of the tubular part and is formed with an opening at the center. The bearing retainer projects from the opening of the bottom part towards the upper side of the tubular part along the central axis and arranges the bearing mechanism on the inner side.

The rotor includes a shaft and a rotor core. The shaft is supported at the bearing mechanism in the bearing retainer, and the upper end part of the shaft projects out from the upper end part of the bearing retainer. The rotor core is formed into a cylindrical shape with a lid covering the upper end part of the bearing retainer, where the lid is connected to the upper end part of the shaft, and the rotor magnet is attached to the side surface.

The electrically operated motor of one example of the present invention includes a shaft, a rotor core, a rotor magnet, a housing, a stator and a bearing mechanism.

The rotor core is a magnetic material formed by a step including pressure molding and sintering of the powder material. The rotor core includes the cylindrical part and is attached to the shaft. The rotor magnet is arranged on the outer peripheral side of the rotor core. The housing includes a tubular part having the central axis as the center.

The stator is fixed to the inner surface of the tubular part, is opposed to the outer peripheral surface of the rotor core, and generates a torque having the central axis as the center with the rotor magnet. The bearing mechanism rotatably supports the shaft with respect to the housing with the central axis as the center.

In the present invention, the region for retaining the bearing mechanism is reduced in the axis direction and thus the motor is miniaturized. The miniaturization of the motor and enhancement in rigidity of the entire housing including the bearing retainer are achieved by forming the housing as one member.

When the motor is used as a pump, the leakage of the fluid in the housing is easily prevented.

Furthermore, the rotor core including the cylindrical part is easily formed, and the manufacturing cost of the motor is reduced.

It should be noted that in describing the positional relationship or the direction of each member as up, down, left and right in the description of the present invention, the positional relationship or the direction merely indicates the positional relation and the direction in the figure and does not indicate the positional relationship and the direction of when incorporated in the actual equipment.

### BRIEF DESCRIPTION OF THE SEVERAL VIEWS OF THE DRAWINGS

The invention, together with objects and advantages thereof, may best be understood by reference to the following description of the presently preferred embodiment together with the accompanying drawings in which:

FIG. 1 is a longitudinal cross sectional view of an electrically operated motor according to a first embodiment of the present invention;

FIG. 2 is a perspective view showing the main components of the stationary section in an exploded manner;

FIG. 3 is a longitudinal cross sectional view showing a housing;

FIG. 4 is a view showing a flow of manufacturing the housing;

FIG. 5A is a cross sectional view showing the state in the process of manufacturing the housing;

FIG. 5B is a cross sectional view showing the state in the process of manufacturing the housing;

FIG. 5C is a cross sectional view showing the state in the process of manufacturing the housing;

FIG. 6 is a perspective view showing the rotor core and the surrounding components thereof in an exploded manner; and

FIG. 7 is an enlarged view of one part of the rotor.

### DETAILED DESCRIPTION OF THE INVENTION

One embodiment of the present invention will now be described. It should be noted that in describing the positional relationship or the direction of each member as up, down, left and right in the description of the present invention, the positional relationship or the direction merely indicates the positional relation and the direction in the figure and does not indicate the positional relationship and the direction of when incorporated in the actual equipment.

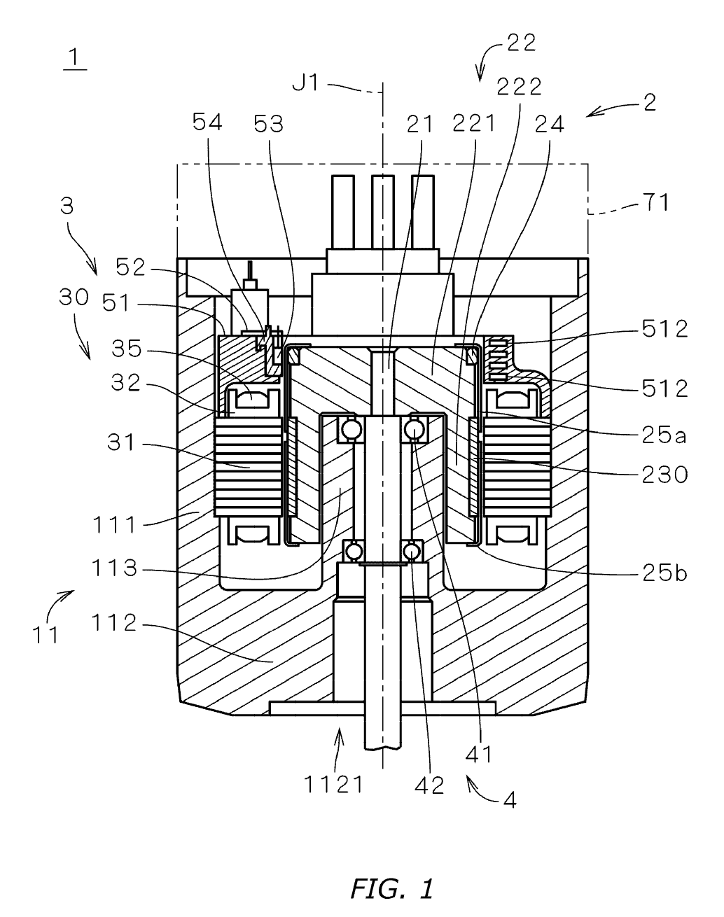

FIG. 1 is a longitudinal cross sectional view of an electrically operated motor 1 according to one embodiment of the present invention. The motor 1 is a so-called brushless motor, and is used for driving the power steering to assist the steering of the automobile and the like. The illustration of parallel diagonal lines at the details of the cross section is partially omitted.

The motor 1 includes a rotor 2, a stationary section 3, a housing 11 having a substantially bottomed cylindrical shape for accommodating the rotor 2 and the stationary section 3, and a bearing mechanism 4.

The housing 11 is formed as one member through aluminum die-casting. The opening on the upper side of the housing 11 is blocked by a lid member, and a control circuit unit (hereinafter referred to as “ECU” (electronic control unit)) 71 for controlling the drive of the motor 1 is attached thereon. A pump is attached on the outer side of the bottom part of the housing 11, and the inside of the pump and the inside of the housing 11 are filled with oil, or fluid for power steering.

The following description is made with the opening side of the housing 1 as the upper side and the bottom part side of the housing 11 as the lower side along the central axis J1 for the sake of convenience, but the central axis J1 does not necessarily coincide with the direction of gravitational force.

The housing 11 includes a tubular part 111 of a substantially cylindrical shape having the central axis J1 as the center, a bottom part 112, and a bearing retainer 113. The bottom part 112 covers the lower end of the tubular part 111, and an opening 1121 is formed at the center of the bottom part 112. The bearing retainer 113 has a substantially cylindrical shape, and is formed extending in the axis direction from the opening 1121 towards the upper end of the tubular part 111.

The rotor 2 includes a shaft 21, a rotor core 22, a rotor magnet 230, a sensor magnet 24, an upper rotor cover 25a and a lower rotor cover 25b.

The shaft 21 has the upper end projecting out from the distal end of the bearing retainer 113 with the central axis J1 as the center. The rotor core 22 includes a cylindrical part 222 having the central axis J1 as the center, and is attached to the upper end of the shaft 21. The rotor magnet 230 is attached to the side surface of the rotor core 22. The sensor magnet 24 is formed into an annular shape having the central axis J1 as the center, and is attached to the outer peripheral surface on the upper side of the rotor core 22. The upper rotor cover 25a covers the upper part of the rotor magnet 230 and the sensor magnet 24. The lower rotor cover 25b covers the lower part of the upper rotor cover 25a and the rotor magnet 230.

The rotor core 22 is a magnetic body (member having magnetism) formed by steps including pressure molding, and sintering of metal powder. The metal powder is, for example, mixed powder containing copper powder of 1 to 2% of the total composition with the iron powder as the main component. The rotor core 22 includes a lid part 221 for blocking the upper end part of the cylindrical part 222. The shaft 21 is press fit to the opening at the center of the lid part 221 so that the rotor core 22 is attached to the shaft 21.

The bearing mechanism 4 supports the rotor core 22 in a so-called cantilevered structure. According to such structure, the bearing mechanism 4 is arranged on the inner side of the rotor core 22 to reduce the length in the axis direction of the motor 1. The bearing mechanism 4 does not need to be positioned on the inner side of the rotor core 22, and only one part of the bearing mechanism 4 may be positioned on the inner side of the cylindrical part 222 of the rotor core 22.

The rotor magnet 23 is an assembly of a plurality of rotor magnet elements (so-called segment magnet), each of which are long in the direction of the central axis J1, and is arranged on the outer peripheral surface of the rotor core 22 in the peripheral direction. The rotor magnet 23 is formed from a sintered material containing neodymium and the like.

The stator 30 is attached to the inner peripheral surface of the tubular part 111 of the housing 11 facing the rotor magnet 23. The central axis of the stator 30 coincides with the central axis J1 of the shaft 21.

The stator 30 includes an annular part (so-called core back) of the core 31 made of magnetic body, a plurality of teeth, an insulator 32, and a coil 35. The plurality of teeth is radially arranged with the central axis J1 as the center, and extends inward in the radial direction from the core back. The insulator 32 covers the plurality of teeth, and the coil 35 is formed by winding conductive wire on the plurality of teeth by way of the insulator 32. The coil 35 is formed by winding the conductive wire in the axis direction on the outer periphery of the plurality of teeth and the insulator 32.

A busbar 51 performed with wire connection for supplying driving current to the coil 35 of the stator 30 is arranged on the upper side of the stator 30, and the busbar 51 is also connected to the ECU 71. A circuit substrate 52 mounted with the Hall element and the like to be hereinafter described is mounted and attached on the upper surface of the busbar 51. The busbar 51 is formed into a substantially annular shape having the central axis J1 as the center, and surrounds the outer periphery of the sensor magnet 24 by way of a gap. The busbar 51 is not limited to the annular shape as long as the outer periphery of the sensor magnet 24 can be surrounded, and may be a U-shape or a C-shape.

In motor 1, the stationary section 3 in which the stator 30, the busbar 51, and the circuit substrate 52 are arranged in the housing 11 is configured, and the bearing mechanism 4 is retained on the inner side of the bearing retainer 113 of the housing 11. The bearing mechanism 4 is a pair of bearings 41, 42 arranged along the central axis J1. Since the shaft 21 is supported at the pair of bearings 41, 42, the rotor section 2 is supported in a relatively rotatable manner with respect to the stationary section 3 with the central axis J1 as the center.

When the driving current is supplied to the stator 30 via the busbar 51, the torque having the central axis J1 as the center is generated between the rotor magnet 23 and the stator 30, thereby rotating the rotor 2.

A Hall element 53 is attached to the lower part of the circuit substrate 52, and the Hall element 53 is held at the sensor holder 54 to be hereinafter described. The Hall element 53 is a sensor for detecting the orientation (i.e., rotating position) of the rotor core 22 along with various electronic components. The Hall element 53 is arranged on the outer side of the sensor magnet 24 with respect to the central axis J1, and the sensor magnet 24 faces the Hall element 53.

The sensor magnet 24 is subjected to multi-pole polarization similar to the rotor magnet 23, where the rotating position of the rotor magnet 23 is indirectly detected when the Hall element 53 detects the magnetic field from the sensor magnet 24. The driving current to the stator 30 is controlled based on the detection result.

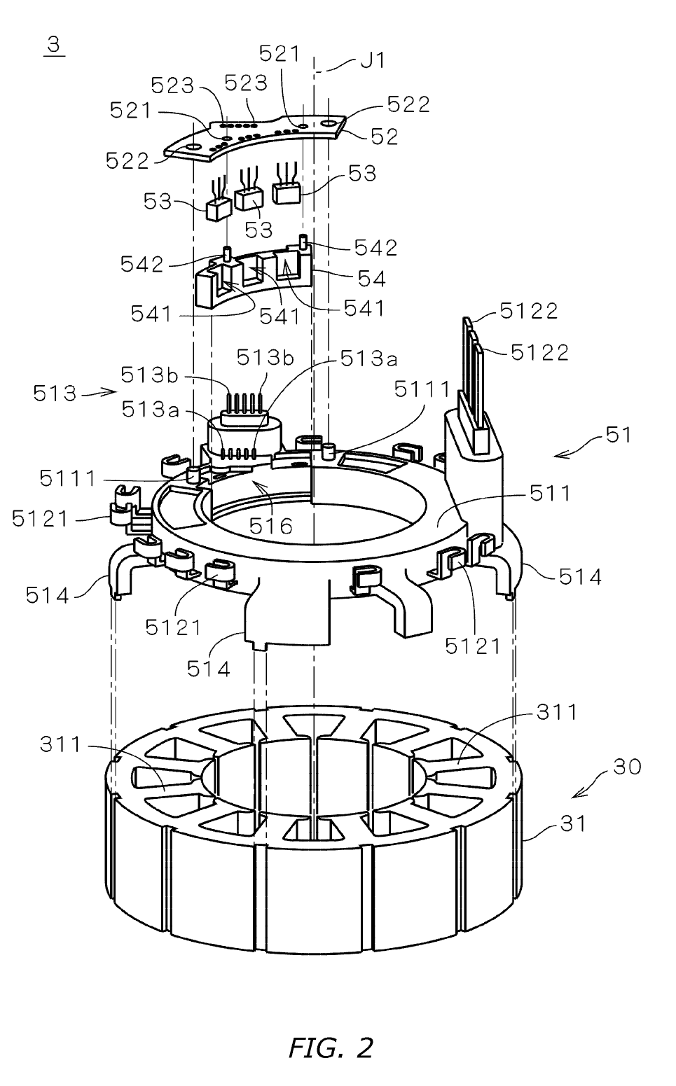

FIG. 2 is a perspective view showing the main components of the stationary section 3 in an exploded manner. Only the core 31 is shown in FIG. 2 with respect to the stator 30, but actually, the stator 30 is prepared with the teeth 311 of the core 31 covered with the insulator 32, and the conductive wire winded from above the insulator 32 to form the coil 35 when the busbar 51 is attached to the stator 30 (see FIG. 1).

The busbar 51 includes an annular resin part 511, a plurality of (four in the present embodiment) circular arc shaped wiring boards 512 (see FIG. 1) and a plurality of connector pins 513. The resin part 511 is formed by injection molding the resin. Each wiring board 512 is stacked with a gap in the axis direction in the resin part 511. The plurality of connector pins 513 are substantially linear metal each having rigidity. Each connector pin 513 is formed into a J-shape, and both end parts 513a, 513b are exposed upward from the resin part 511.

The wiring board 512 includes a plurality of terminals 5121 for wire connecting with the stator 30, and a flat terminal 5122 for wire connecting with the external current supplying section. The region for connecting the plurality of terminals 5121 and the flat terminal 5122, and one part between both end parts of the connector pin 513 are molded so as to be positioned in the resin part 511 through insert molding in time of injection molding.

One end part (hereinafter referred to as “substrate side end part”) 513a to be connected to the circuit substrate 52 out of the end parts of each connector pin 513 projects out vertically from the surface facing the circuit substrate 52 of the resin part 511. The end part (hereinafter referred to as “connector side end part”) 513b on the side opposite the circuit substrate 52 of the connector pin 513 is removably connected to the external connector (not shown) for outputting the signal to the ECU 71.

The busbar 51 is electrically connected to the stator 30 when the conductive wire (not shown) from the coil 35 is connected to the terminal 5121 on the outer periphery by caulking. A plurality of leg parts 514 arranged on the outer periphery of the busbar 51 contact the upper surface of the core 31. Furthermore, the projection portion formed at the distal end of each leg part 514 engages a longitudinal groove on the outer peripheral surface of the core 31, so that the busbar 51 is positioned with respect to the core 31.

A circular arc shaped concave part 516 made of resin and in which the circular arc shaped sensor holder 54 is accommodated is formed in the inner peripheral surface of the busbar 51. The Hall element 53 is attached to the circuit substrate 52. First, the Hall element 53 is inserted and held at each concave part 541 of the sensor holder 54. The sensor holder 54 is then fixed to the surface on the busbar 51 side of the circuit substrate 52 with the terminals of the Hall element 53 inserted to a hole formed in the land of the circuit substrate 52.

After the projection portions 542 of the sensor holder 54 are inserted into the holes 521 of the circuit substrate 52, the sensor holder 54 is fixed to the circuit substrate 52 by thermal welding of thermally melting and squashing the projection portions 542. Thereafter, the terminals of the Hall element 53 are joined to the circuit substrate 52 by soldering.

The busbar 51 is fixed the circuit substrate 52 after the sensor holder 54 is attached to the circuit substrate 52. First, the sensor holder 54 is fitted into the concave part 516. Two resin projection portions 5111 arranged on the upper surface of the resin part 511 are inserted to the hole 522 of the circuit substrate 52, and the substrate side end parts 513a of the plurality of connector pins 513 are inserted to the holes 523 of the circuit substrate 52. The circuit substrate 52 is strongly fixed to the busbar 51 through thermal welding of thermally melting and squashing the projection portions 5111, and furthermore, the substrate side end part 513a is joined to the circuit substrate 52 by soldering.

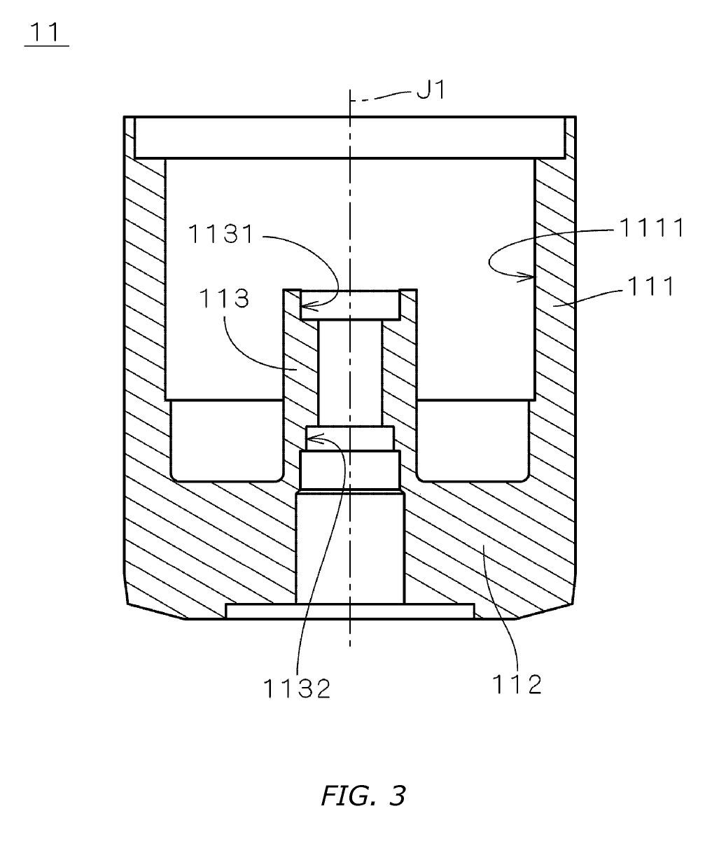

FIG. 3 is a longitudinal cross sectional view showing the housing 11. The housing 11 is formed as one member through aluminum die-casting. A first bearing retaining surface 1131 and a second bearing retaining surface 1132 for retaining the bearing mechanism 4 are formed in the bearing retainer 113 as a part of the inner surface, and an inner surface 1111 of high precision used in attaching the stator 30 is formed on the inner side of the tubular part 111.

The bearing on the output side (pump side) is normally formed to be larger if the sizes of the pair of bearings differ from each other, but in the motor 1, the bearing 41 to be retained at the distal end side of the bearing retainer 113 out of the pair of bearings is greater than the bearing 42 held on the bottom part 112 side (see FIG. 1).

Therefore, the thickness dimension of the bearing retainer 113 in the vicinity of the second bearing retaining surface 1132 can be increased, and the rigidity between the bearing retainer 113 and the bottom part 112 is maintained high. When referring to the bearing being “large”, not only are the outer diameter and the ring width of the bearing large, but the thickness in the axis direction is also thick.

A cantilevered structure of holding the bearing mechanism 4 with one member is adopted in the motor 1, as described above. Thus, the first bearing retaining surface 1131 and the second bearing retaining surface 1132 are continuously formed, and the degree of coaxiality of the pair of bearings 41, 42 can be easily enhanced and the shaft 21 can be strongly supported.

Furthermore, since the rotor section 2 is supported by the cantilevered structure, the region of retaining the bearing mechanism 4 can be shorted in the axis direction, and the motor 1 can be miniaturized since the bearing retainer 113 and the bearing mechanism 4 are positioned in the rotor core 22.

Moreover, miniaturization of the motor 1 and enhancement in the rigidity of the entire housing 11 including the bearing retainer 113 are achieved by forming the tubular part 111, the bottom part 112 and the bearing retainer 113 as an integrated configuration in the housing 11.

The sensor magnet 24 is arranged at one part (upper part) of the rotor core 22, and the sensor magnet 24 and the Hall element 53 are arranged so as to face each other in the radial direction. A configuration in which the busbar 51 overlaps one part of the rotor core 22 in the radial direction is thus obtained, whereby the length in the axis direction of the motor 1 is reduced.

The motor 1 is used as a power source of a pump for sending out oil or fluid, and the inside of the housing 11 is filled with oil, as described above. In the present invention, the leakage of fluid is easily prevented by forming the housing 11 as one member, and consequently, the reliability of the system in assisting the steering of the automobile is enhanced.

Sealing agent can be appropriately applied to the joined parts of each terminal of the busbar 51, Hall element 53, and other electronic components etc. and the circuit substrate 52.

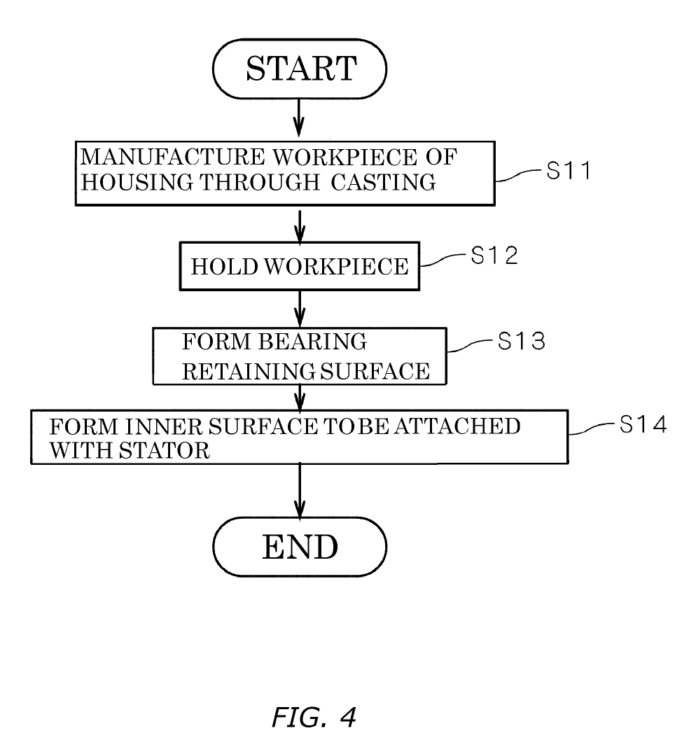

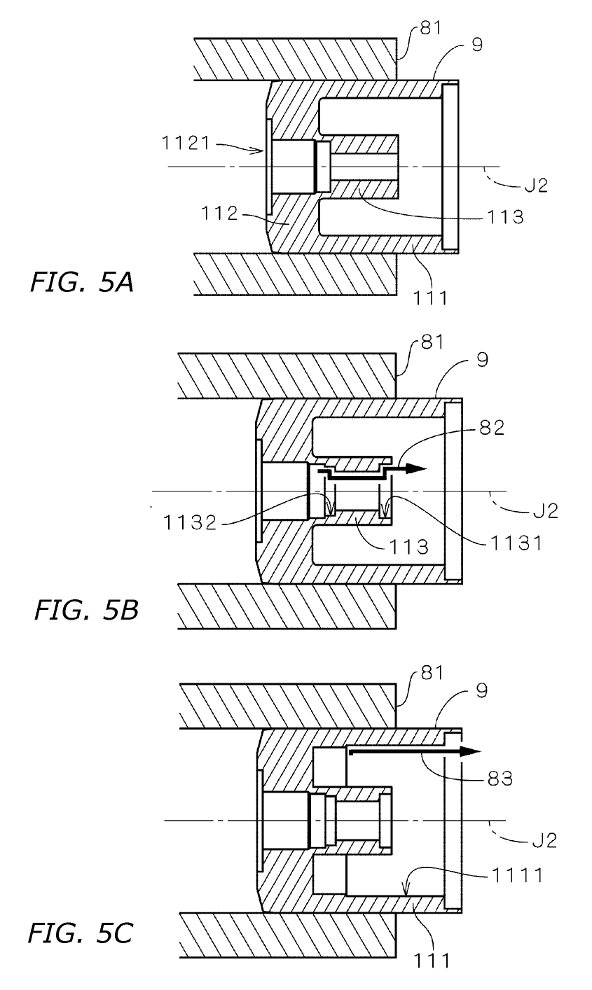

A method of manufacturing the housing 11 of the motor 1 will now be described. FIG. 4 is a view showing the flow of manufacturing the housing 11, and FIGS. 5A to 5C are cross sectional views showing the states in the process of manufacturing the housing 11.

First, a workpiece 9 of the housing 11 is formed through casting (step S11), and after the outer peripheral surface of the workpiece 9 is appropriately shaped, the workpiece 9 is held at a chuck 81, which is the retainer of NC turning machine as shown in FIG. 5A (step S12).

As shown in FIG. 5A, the workpiece 9 includes the tubular part 111 of a substantially cylindrical shape having a predetermined central axis J2 as the center, the bottom part 112, and the bearing retainer 113 of a substantially cylindrical shape. The bottom part 112 covers one end of the tubular part 111 (left side in FIG. 5A, and hereinafter referred to as “holding end”) and includes an opening 1121 at the center. The bearing retainer 113 projects towards the other end side (right side in FIG. 5A, hereinafter referred to as “processing end”) of the tubular part 111 along the central axis J2 from the opening 1121.

The reference characters are the same as in FIG. 3. The chuck 81 relatively rotates the workpiece 9 with the central axis J2 extending from the processing end to the holding end of the workpiece 9 as the center with respect to a tool (i.e., tool such as drill and turning tool).

Thereafter, the processing by the turning tool in the bearing retainer 113 is performed with the holding end side of the workpiece 9 held at the chuck 81, as shown in FIG. 5B. In FIG. 5B, the trajectory of the turning tool is indicated by reference character 82. The holding end side on the inside of the bearing retainer 113 is machined to an annular shape having the central axis J2 as the center, thereby forming the second bearing retaining surface 1132 which is a cylindrical surface having the central axis J2 as the center. The second bearing retaining surface 1132 is the retaining surface for the bearing 42 shown in FIG. 1.

The inner surface of the bearing retainer 113 is then machined parallel to the central axis J2, so that the inner surface of the portion on the processing end side from the second bearing retaining surface 1132 is shaped to a diameter smaller than the second bearing retaining surface 1132.

When the turning tool moves to the vicinity of the distal end of the processing end side of the bearing retainer 113, the machining diameter is increased, and as the turning tool moves to the distal end of the bearing retainer 113 in such state, the first bearing retaining surface 1131, which is a cylindrical surface having the central axis J2 as the center, is formed (step S13). The first bearing retaining surface 1131 is the retaining surface for the bearing 41 shown in FIG. 1.

The type of turning tool used in forming each region may be appropriately changed while the turning tool moves along the trajectory 82, and the turning tool may be reciprocated for deeper digging when forming the bearing retaining surface. The order of machining each region may be appropriately changed.

After the first bearing retaining surface 1131 and the second bearing retaining surface 1132 are formed on the inside of the bearing retainer 113, the inner surface 1111 or a substantially cylindrical surface is then formed. The inner surface 1111 is formed by machining the inside of the tubular part 111 with the turning tool in parallel to the central axis J2 as shown with an arrow 83 with the workpiece 9 being rotated while being held by the chuck 81 (step S14), as shown in FIG. 5C. The manufacturing of the housing 11 is thereby completed.

The inner diameter of the inner surface 1111 is equal to the outer diameter of the stator 30, and acts as a surface for attaching the stator 30 at satisfactory precision. Step S14 may be performed before step S13.

In the manufacturing method shown in FIGS. 5A to 5C, the first bearing retaining surface 1131, the second bearing retaining surface 1132 and the inner surface 1111 are formed with the workpiece 9 held at the chuck 81 or the same retainer without being transferred between different members, as described above. The degree of coaxiality of the pair of bearings 41, 42 is thus readily enhanced, and the degree of coaxiality of the bearing mechanism and the stator 30 is also easily enhanced. Furthermore, increase in cost caused by the chucking task is reduced since the processing of the main components of the housing 11 is performed only in one chucking.

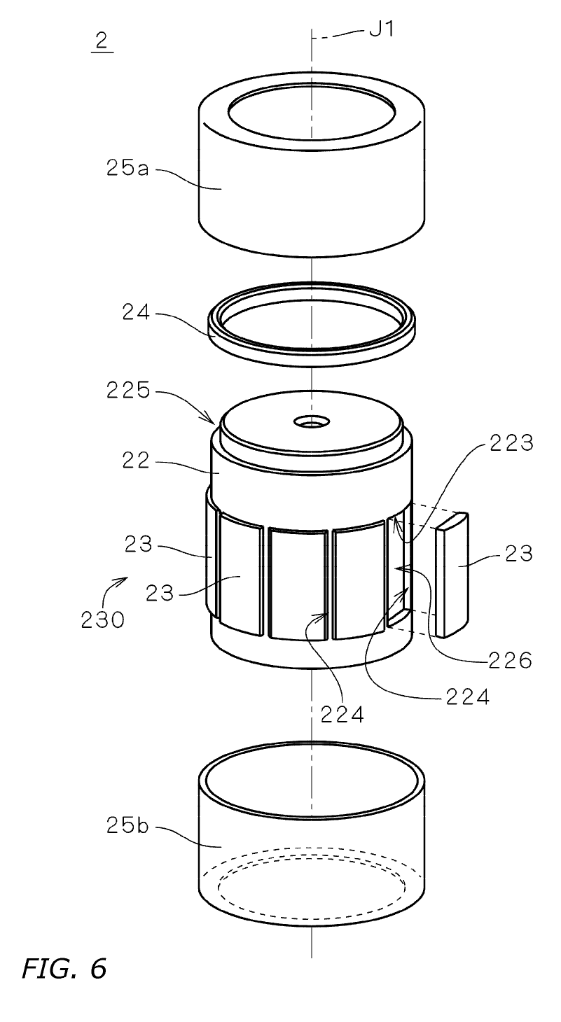

FIG. 6 is a perspective view showing the rotor core 22 and the surrounding components thereof in an exploded manner. As shown in FIG. 6, the rotor magnet 230 is a collection of a plurality of rotor magnet elements 23 (so-called segment magnet), each of which are long in the central axis J1 direction, and is arranged on the outer peripheral surface of the rotor core 22 in the peripheral direction. The sintered material containing neodymium and the like is used for the rotor magnet element 23.

The rotor core 22 includes a first magnet contacting part 223, a second magnet contacting part 224, and a sensor magnet contacting part 225. The first magnet contacting part 223 determines the position in the central axis J1 direction of each rotor magnet element 23 by contacting the upper end of each rotor magnet element 23. The second magnet contacting part 224 determines the position in the peripheral direction of each rotor magnet element 23. The sensor magnet contacting part 225 determines the position in the central axis J1 direction of the sensor magnet 24 by contacting the lower surface of the sensor magnet 24.

The upper side rotor cover 25a and the lower side rotor cover 25b are formed into a substantially cylindrical shape by stainless steel. The upper side rotor cover 25a has an edge that extends inward at the upper end, and the lower side rotor cover 25b has an edge that extends inward at the lower end.

The upper side cover 25a is placed from the upper side of the rotor core 22 attached with the plurality of rotor magnets 230 and the sensor magnet 24, and is fixed with an adhesive. The lower side rotor cover 25b is placed from the lower side of the rotor core 22 and fixed with an adhesive. Therefore, the rotor magnet 230 and one part of the sensor magnet 24 are covered by the upper side rotor cover 25a, and not only the rotor magnet elements 23 but also the sensor magnet 24 can be covered by two rotor covers 25a, 25b, whereby the slip-off of the magnets can be reliably prevented. Furthermore, the number of components of the rotor section 2 can be reduced since the sensor magnet 24 is covered b a configuration similar to that of when covering only the rotor magnet element 23.

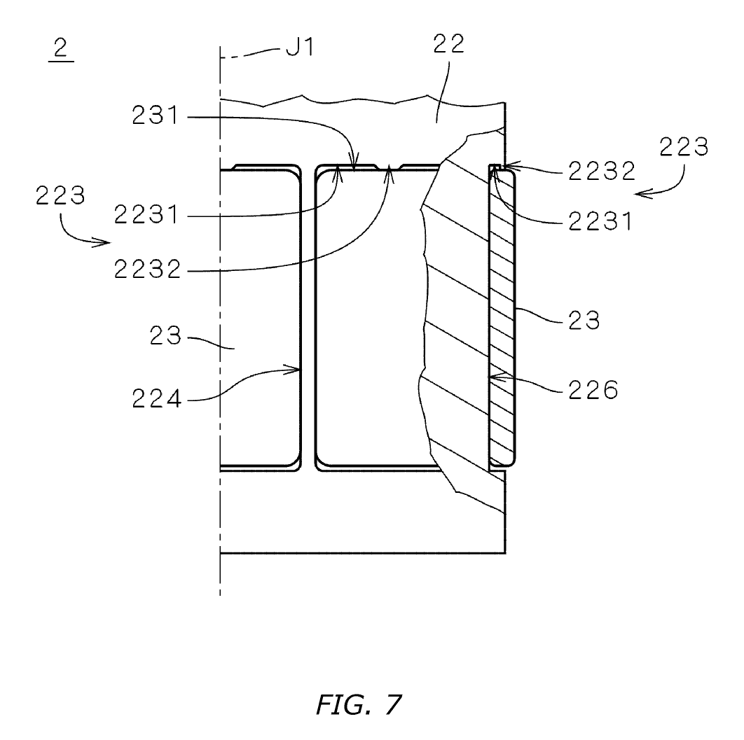

FIG. 7 is an enlarged view of one part of the rotor section 2. In FIG. 7, one section is shown in cross section. The first magnet contacting part 223 includes an opposing surface 2231 and a projecting portion 2232. The opposing surface 2231 faces the upper end face 231 of the rotor magnet element 23. The projecting portion 2232 projects from the opposing surface 2231 towards the upper end face 231 of the rotor magnet element 23.

The projecting portion 2232 is spaced apart from the surface 226 of the rotor core 22 contacting the surface on the central axis J1 side of the rotor magnet element 23 (i.e., back surface of rotor magnet element 23). The projecting portion 2232 projects from the opposing surface 2231 and contacts the upper end face 231 of the rotor magnet element 23.

When the rotor magnet element 23 is fixed to the rotor core 22, the upper end face 231 of the rotor magnet element 23 first contacts the projecting portion 2232 of the first magnet contacting part 223, as shown in FIG. 7. Therefore, the positioning in the central axis J1 direction of the rotor magnet element 23 is accurately performed. Furthermore, the projecting portion 2232 reduces the area contacting the upper end face 231 of the rotor magnet element 23. The leakage of the magnetic flux from the upper and lower end face of the rotor magnet element 23 to the rotor core 22 can be suppressed and the driving efficiency can be enhanced by forming a gap between the upper end face 231 and the opposing surface 2231, and between the lower end face of the rotor magnet element 23 and the rotor core 22.

As shown in FIGS. 6 and 7, the positioning in the peripheral direction of the rotor magnet element 23 is accurately performed by contacting one of the side surfaces of the rotor magnet element 23 to the second magnet contacting part 224.

The width of the concave part to which the rotor magnet element 23 is fitted is formed to the width the rotor magnet element 23 is fitted by running fit. In this case, the surfaces on both sides of the concave part function as the second magnet contacting part 224 for positioning the rotor magnet element 23 in the peripheral direction since the surfaces on both sides of the concave part substantially contact the rotor magnet element 23. The rotor magnet element 23 is fixed to the rotor core 22 by adhering the back surface thereof to the surface 226.

In the motor 1, the bearing mechanism 4 is held in the bearing retainer 113 of the housing 11 formed as one member, and the rotor core 22 is supported by a so-called cantilever structure in which the bearing mechanism 4 is arranged inside, as described above.

Although the cross sectional shape of the rotor core 22 perpendicular to the central axis changes in a complicated manner, such rotor core 22 having a complicated shape can also be easily formed since the rotor core 22 is formed through steps of pressure molding, sintering and the like of metal powder materials. Furthermore, the manufacturing cost of the motor can be reduced, and the shape of the rotor core 22 can be freely designed.

The shape of the rotor core 22 is not limited to that shown in FIG. 1, but the cross sectional shape perpendicular to the central axis changes in a complicating manner if the rotor core 22 is connected to the shaft 21 and includes at least a cylindrical part. In such case, the rotor core 22 becomes difficult to form by stacking electromagnetic steel plates, and machining the metal. However, such problem can be solved since the rotor core 22 is manufactured from powder material.

Furthermore, the first magnet contacting part 223, the second magnet contacting part 224, and the sensor magnet contacting part 225 for determining the attachment position of the sensor magnet 24 can be easily formed by manufacturing the rotor core 22 from powder material. The first magnet contacting part 223 determines the attachment position of the rotor magnet element 23 with respect to the central axis direction and the peripheral direction.

The sensor magnet 24 can be polarized with the rotor magnet element 23 and the sensor magnet 24 integrally attached to the rotor core 22. The polarizing positions of the rotor magnet 230 and the sensor magnet 24 are matched at high precision.

A special member or jig for positioning the rotor magnet element 23 and the sensor magnet 24 is not necessary in the motor 1.

In addition, the rotor magnet element 23 and the sensor magnet 24 are covered by the upper side rotor cover 25a and the lower side rotor cover 25b.

Therefore, the number of components of the rotor section 2 is reduced, and the manufacturing cost and the number of man hour for the motor 1 are reduced.

Furthermore, the sensor magnet 24 is arranged on the outer peripheral surface of the upper end of the rotor core 22, and the sensor magnet 24 and the Hall element 53 are arranged so as to face each other in the radial direction. According to the relevant configuration, the amount the busbar 51 projects from the rotor core 22 towards the side opposite the stator 30 is reduced, and the length in the axis direction of the motor 1 is reduced.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

The housing 11 of the motor 1 is formed as one member through aluminum die-casting, but may be formed as one member by materials other than aluminum. Furthermore, the housing 11 realizes miniaturization of the motor 1 by accommodating each member of the motor 1 in one member. The miniaturization of the entire system including the mechanism using the motor 1 may be realized by forming the other components of the mechanism using the motor 1 and the housing 11 as one member. For example, the casing of the pump and the housing 11 may be integrally formed.

The shapes of the first magnet contacting part, the second magnet contacting part, and the sensor magnet contacting part can be deformed into various forms.

For example, a convex part may be arranged on the upper end of the rotor magnet element and the projecting portion may be omitted from the opposing surface of the concave part of the rotor core, so that the attachment position of the rotor magnet element is determined by contacting the convex part of the magnet to the opposing surface.

Moreover, the concave part to which the rotor magnet element is fitted may be omitted, and the projection portion arranged on the outer surface of the rotor core may function as the first magnet contacting part and the second magnet contacting part. For example, a projection portion that projects to the outer side from the outer surface of the rotor core and further projects to the lower side thereby contacting the upper end face of the rotor magnet element, or a projection portion that projects diagonally downward from the outer surface of the rotor core may be arranged.

The sensor magnet may be polarized before attachment, in which case, a D-cut is readily formed on the rotor core for positioning in the peripheral direction.

The sensor magnet may be formed through injection molding, and positioning of the sensor magnet may be performed with the projection portion formed the gate part and the concave part formed at the rotor core.

Furthermore, the upper side rotor cover 25a and the lower side rotor cover 25b are formed into a substantially cylindrical shape with stainless steel in the motor 1, but may be formed with non-magnetic materials (e.g., resin) other than stainless steel.

The bearing mechanism 4 may include a bearing other than the pair of bearings 41, 42, and the shaft may be supported by oil retaining sleeve.

The shaft does not need to be supported with a cantilever structure, and may be supported by center-lever structure. That is, the bearing mechanism for rotatably supporting the shaft with respect to the housing may be separated to upper part and the lower part with respect to the rotor core.

The upper side rotor cover and the lower side rotor cover may be integrally arranged, and the rotor magnet and the sensor magnet may be entirely covered by one rotor cover.

The more 1 has high reliability with respect to oil leakage, and thus may be used in electrically operated brake system, electromagnetic suspension, and transmission system in addition to the electrically operated power steering of the automobile, and may be used in various systems for assisting the driving operation of the vehicle other than an automobile. The motor may also be used in various systems where the motor including a rotor core of a complicated shape is used.

The motor 1 may also be used in a pump for fluid other than oil.

It should be apparent to those skilled in the art that the present invention may be embodied in many other specific forms without departing from the spirit or scope of the invention. Therefore, the present invention is not to be limited to the details given herein, but may be modified within the scope and equivalence of the appended claims.

What is claimed is:

1. An electrically operated motor comprising:
a stationary section including a stator;
a rotor including a rotor magnet for generating, with the stator, a torque having a central axis as a center;
a bearing mechanism for rotatably supporting, with the central axis as the center, the rotor with respect to the stationary section; and
a housing of a substantially bottomed cylindrical shape formed as one member for accommodating the stationary section and the rotor; wherein:
the housing includes
a tubular part having attached the stator at an inner surface thereof, wherein the inner surface of the tubular part is a substantially cylindrical surface,
a bottom part for covering a lower end of the tubular part and formed with an opening at the center, and
a bearing retainer of a substantially cylindrical shape accommodated in the tubular part of the housing for retaining therein the bearing mechanism on the inner side thereof, wherein the bearing retainer is concentric with the central axis and extends via the opening towards an upper side of the tubular part along the central axis; and
the rotor includes
a shaft supported by the bearing mechanism in the bearing retainer, and having an upper end part thereof projecting from an upper end part of the bearing retainer, and
a rotor core of a cylindrical shape with lid for covering the upper end part of the bearing retainer, wherein the lid is connected to the upper end part of the shaft, and the rotor magnet is attached to the side surface.

2. The motor according to claim 1, wherein the bearing mechanism includes a pair of bearings arranged along the central axis.

3. The motor according to claim 2, wherein, of the pair of bearings, a bearing arranged at an upper position relative to a bearing at a lower position is larger.

4. The motor according to claim 1, wherein:
the motor is used as a power source of a pump for sending out fluid; and
the housing is filled with fluid.

5. The motor according to claim 4, wherein:
the fluid is oil; and
the motor is used in a system for assisting a driving operation of a vehicle.

6. The motor according to claim 5, wherein the motor assists a steering of an automobile.

7. A housing manufacturing method of manufacturing a housing for an electrically operated motor, the method comprising the steps of:
forming through casting a workpiece of a housing including a tubular part of a substantially cylindrical shape having a central axis as a center, a bottom part for covering a lower end of the tubular part and formed with an opening at the center, and a bearing retainer of a substantially cylindrical shape extending via the opening towards an upper side of the tubular part along the central axis;
holding the workpiece with a chuck;
machining an inside of the bearing retainer and forming bearing retaining surfaces by relatively rotating the workpiece with respect to a machining tool with the central axis as the center while the workpiece is being held at the chuck; and
machining the inside of the tubular part and forming an inner surface by relatively rotating the workpiece with respect to the machining tool with the central axis as the center while the workpiece is held at the chuck.

8. An electrically operated motor comprising:
a shaft;
a rotor core including a cylindrical part having a central axis substantially concentric with that of the shaft, and attached to the shaft, wherein the rotor core is a magnetic material formed by steps including pressure molding and sintering of powder material;
a rotor magnet arranged on an outer peripheral side of the rotor core;
a housing including a tubular part having the central axis as a center;
a stator, fixed on an inner side surface of the tubular part and opposed to the outer peripheral surface of the rotor core, for generating a torque having the central axis as the center; and
a bearing mechanism for rotatably supporting the shaft with respect to the housing with the central axis as the center.

9. The motor according to claim 8, wherein the rotor core includes a lid for blocking an upper end part of the cylindrical part of the housing, the lid being attached to the shaft.

10. The motor according to claim 8, wherein:
the rotor magnet includes a plurality of rotor magnet elements; and
the rotor core includes a first magnet contacting part for positioning the plurality of rotor magnet elements in an axial direction, and a second magnet contacting part for positioning the plurality of rotor magnet elements in a peripheral direction, wherein the first magnet contacting part and the second magnet contacting part contact each of the plurality of rotor magnet elements so as to determine said positions thereof.

11. The motor according to claim 10, wherein:
the first magnet contacting part includes a projecting portion; and
the projecting portion projects towards an upper end face of the rotor magnet so as to contact the upper end face while being spaced apart from a surface of the rotor core which contacts an inner surface of the rotor magnet element.

12. The motor according to claim 8, further comprising:
a sensor magnet of an annular shape having the central axis as the center, attached to the outer peripheral surface of the rotor core; and
a sensor, arranged on the outer side of the sensor magnet with respect to the central axis, for detecting a position of the rotor core by detecting the magnetic field from the sensor magnet, wherein:
the rotor core includes a sensor magnet contacting part for positioning the sensor magnet in an axial direction by contacting the sensor magnet.

13. The motor according to claim 12, wherein:
the sensor magnet is arranged on the outer peripheral surface on an upper part of the rotor core;
the motor further includes a busbar, attached to an upper end part of the stator, for surrounding an outer periphery of the sensor magnet; and
the sensor is arranged on the inner peripheral part of the busbar.

14. The motor according to claim 12, wherein the rotor core further includes a rotor cover for covering the sensor magnet and at least one part of the rotor magnet.
